(19) United States
(12) Patent Application Publication
(10) Pub. No.: US 2008/0215310 A1
(43) Pub. Date: Sep. 4, 2008

(54) Method and system for mapping a natural language text into animation

(76) Inventor: Pascal Audant, Sainte-Foy (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/586,676

(22) Filed: Oct. 26, 2006

Related U.S. Application Data
(60) Provisional application No. 60/730,878, filed on Oct. 28, 2005.

(51) Int. Cl. G06F 17/27

(52) U.S. Cl. 704/9

(57) ABSTRACT

A method for analyzing a natural language sentence describing an action, to create an action structure to be used in creating an animation of the action, the method comprising: processing the natural language sentence to create a grammatical tree comprising an action word and its associated values; providing constructs for the action word, each of the constructs having parameter types for defining the action expressed by the action word; identifying from the constructs at least one construct wherein at least one of the parameter types can take on at least one of the associated values thereby defining a matching value; and recording the at least one of the parameter types from the at least one construct as well as the matching value, thereby creating the action structure.

### CROSS-REFERENCE TO RELATED APPLICATIONS

The present application claims priority under 35USC§119(e) of U.S. provisional patent application 60/730,878 filed on Oct. 28, 2005 and titled METHOD AND SYSTEM FOR MAPPING A NATURAL LANGUAGE TEXT INTO ANIMATION. The specification of the foregoing provisional application is hereby incorporated by reference.

### FIELD OF THE INVENTION

The invention relates to a system and method for generating an animated sequence from text. More specifically, it relates to a system and method allowing to map a high-level scenario-like description into an animation.

### BACKGROUND OF THE INVENTION

Within the current context of globalization, there exists more than ever a need for a universal language that will facilitate cultural and economic exchanges.

Though much time and effort has been invested in finding automated translation systems for natural languages, translation between languages suffers from many drawbacks. The major problem is the lack of compatibility between the complexity of natural languages, representative of the unique and creative human expression, and the mechanical, algorithm-like nature of current translation systems.

At the same time, as images and visual expressions have come to define new communication means, such as cinema, television, computers, etc. it becomes necessary to integrate such images into a universally understood representation of ideas. Indeed, some systems have avoided the translation problem by attempting to represent concepts expressed in natural languages with images. Unfortunately, such efforts have failed to various degrees in grasping the complexity of natural language expression. Some early systems have attempted representation using only static images. Some systems try to identify key concepts or words in a text and then employ images to represent them, without however providing a coherent sequence that correctly captures the meaning of the text. Other systems providing animation translations of text are built from animation sequences edited together, thus requiring an extensive database of mini-animation clips, which is of limited use.

There exists therefore a need for a method and system allowing to analyze natural language text and to render it in a form that can be easily automatically translated, with particular emphasis on the meaning/concepts in the text.

### SUMMARY OF THE INVENTION

Accordingly, the present invention provides a method and a system allowing to map a natural language action text into animation.

The present invention also provides a system and method for organizing action words and modeling ideas expressed in natural language, such that these can easily be translated into animations.

According to a first broad aspect of the present invention, there is provided a method for producing an animation from an action structure, the action structure formed by analyzing a natural language sentence expressing an action, the method comprising: processing the sentence to create a grammatical tree comprising an action word and its associated values; providing constructs for the action word, each of the constructs having parameter types for defining the action expressed by the action word; identifying from the constructs at least one construct wherein at least one of the parameter types can take on at least one of the associated values thereby defining a matching value; recording the at least one of the parameter types from the at least one construct as well as the matching value, thereby creating the action structure; and producing an animation from the action structure.

According to a second broad aspect of the invention, there is provided a system for producing an animation from an action structure expressing an action, the action structure formed by analyzing a natural language sentence describing the action, the system comprising: a database for storing constructs of an action word, each of the constructs having parameter types for defining the action expressed by the action word; a processor module for receiving the sentence and processing the sentence to create a grammatical tree having an action word and its associated values; a construct selector receiving the grammatical tree and accessing the database to identify from the constructs, at least one construct wherein at least one of the parameter types can take on at least one of the associated values defining a matching value; an action structure builder for receiving the at least one construct and the grammatical tree, and for recording the at least one of the parameter types from the at least one construct as well as the matching value, thereby creating the action structure; and an animation engine for producing an animation from the action structure.

According to a third broad aspect of the invention, there is provided a method for analyzing a natural language sentence describing an action, to create an action structure to be used in creating an animation of the action, the method comprising: processing the natural language sentence to create a grammatical tree comprising an action word and its associated values; providing constructs for the action word, each of the constructs having parameter types for defining the action expressed by the action word; identifying from the constructs at least one construct wherein at least one of the parameter types can take on at least one of the associated values thereby defining a matching value; and recording the at least one of the parameter types from the at least one construct as well as the matching value, thereby creating the action structure.

According to a fourth broad aspect of the invention, there is provided a system for analyzing a natural language sentence describing an action, to create an action structure to be used in creating an animation of the action, the system comprising: a database for storing constructs of an action word, each of the constructs having parameter types for defining the action expressed by the action word; a processor module for receiving the sentence and processing the sentence to create a grammatical tree having an action word and its associated values; a construct selector receiving the grammatical tree and accessing the database to identify from the constructs, at least one construct wherein at least one of the parameter types can take on at least one of the associated values defining a matching value; and an action structure builder for receiving the at least one construct and the grammatical tree, and for recording the at least one of the parameter types from the at least one construct as well as the matching value, thereby creating the action structure.

### BRIEF DESCRIPTION OF THE DRAWINGS

These and other features, aspects and advantages of the present invention will become better understood with regard to the following description and accompanying drawings wherein:

FIG. 1 is a system for analyzing a natural language text and building a model therefrom according to the present invention;

FIG. 2a is a block diagram of an Invariant Significant of Movement (ISM) construct structure according to the present invention;

FIG. 2b is a continuation portion of the block diagram of FIG. 2a showing requests of an Invariant Significant of Movement structure according to one embodiment of the present invention;

FIG. 3a is a flow chart of a method for analyzing a natural language text and building an action structure according to the present invention;

FIG. 3b is a continuation of the flow chart of FIG. 3a;

FIG. 3c is a continuation of the flow chart of FIG. 3b;

FIG. 3d is a continuation of the flow chart of FIG. 3c;

FIG. 4 is a block diagram of a grammatical tree built by natural language processing according to the present invention;

FIG. 5 is a block diagram of an action structure of an exemplary sentence analyzed according to the method of the present invention; and

FIG. 6 is a block diagram of an example of a computer system suitable for implementing the present invention.

### DETAILED DESCRIPTION OF THE PREFERRED EMBODIMENT

The present invention provides a method to convert a scenario-like text expressed in natural language to a data structure that contains enough information to be translated easily to an animation that represents the action described in the text. The method involves the use of Invariant Significant of Movement (ISM) structures.

An ISM structure designates a certain type of movement that is identical for a plurality of action words representing different activities. An action word is usually a verb, but it can be another kind of word representing an action such as the noun “walk”. Such ISM structures can be used as building blocks in a system for modeling the structure of a natural language text so that it may be mapped into an animation. For example, the gesture, with a raised arm moving back and forth is an ISM structure that can be used to represent any one of the following verbs: to wash, to brush, to polish, to clean, to wipe, to greet, etc. A simple observation of such a gesture can lead an eye witness to think of a plurality of meanings for the gesture. Conversely, the method allows to represent by the same animated image any of the above-mentioned verbs. The sentences “Paul washes the window” and “Paul brushes the horse” are therefore equivalent from the point of view of the animation since they both represent a movement that can be characterized by having: an actor performing an action+an ISM (i.e. the action)+an actor receiving the action. This way, a single ISM can conveniently be used to represent in animated form a plurality of natural language action words.

In order to analyze a sentence and extract the ISM, a database of ISMs and parameters needs to be built. The parameters of each ISM are different. For example, if the ISM represents the action of giving something, a parameter would be the object that is given. If the ISM is a movement, the origin and destination of the movement are among the parameters. Some parameters are mandatory, in that the animation cannot be represented without them. For example, it is impossible to represent movement without knowing the origin and destination of the movement. While some parameters are mandatory, others may be optional.

For each ISM, there is also a list of passions in the database. A passion is an attribute of the considered movement that can be changed without modifying the nature of the movement, so it continues to belong to the same ISM. An example of passion for a movement is its speed. Most action words are actually a combination of an ISM and a given value for one or more passions. For example, “to trot”, which is “to walk quickly”, corresponds to the same ISM as “to walk”, but has a higher value for the speed passion.

When building the database of ISM structures, different ISMs could be provided for the same verb (when the action word is a verb) which has a transitive and intransitive form. Transitive verbs carry the action of a subject and apply it to an object, more precisely, by specifying what the subject (agent) does to something else (object). Intransitive verbs, however, are those that do not take direct objects.

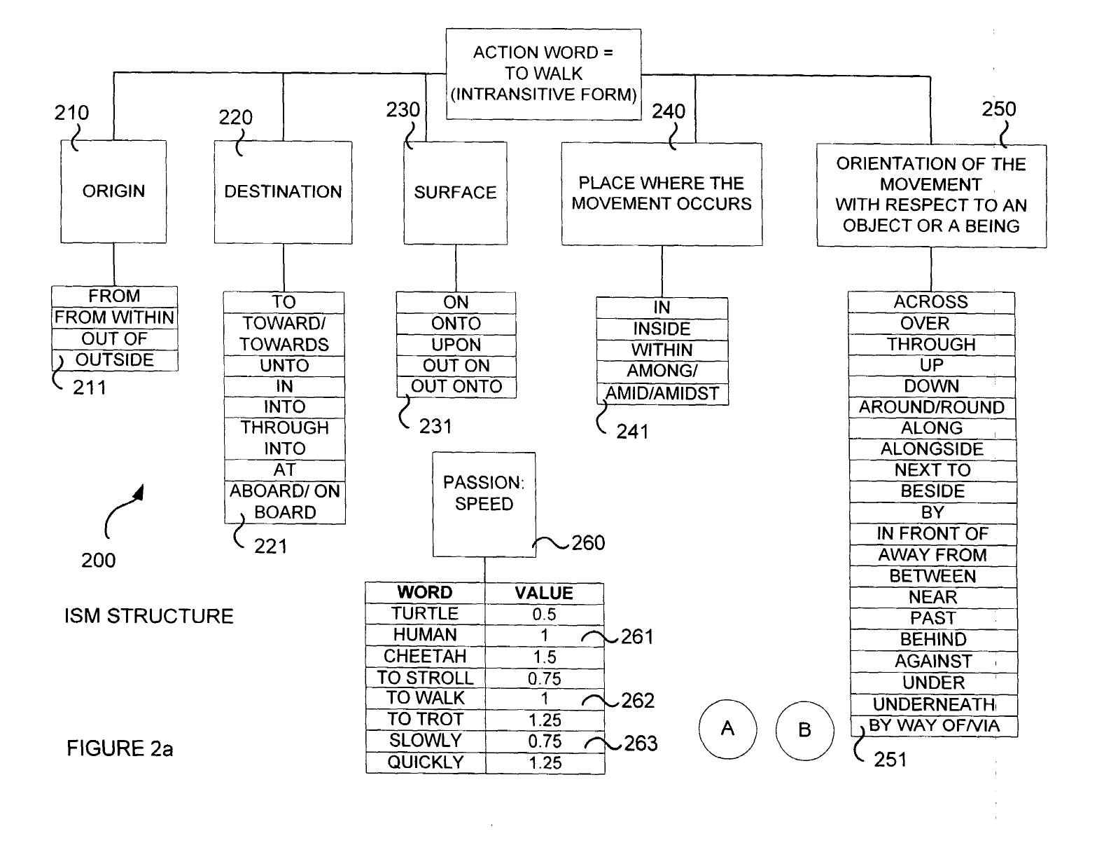

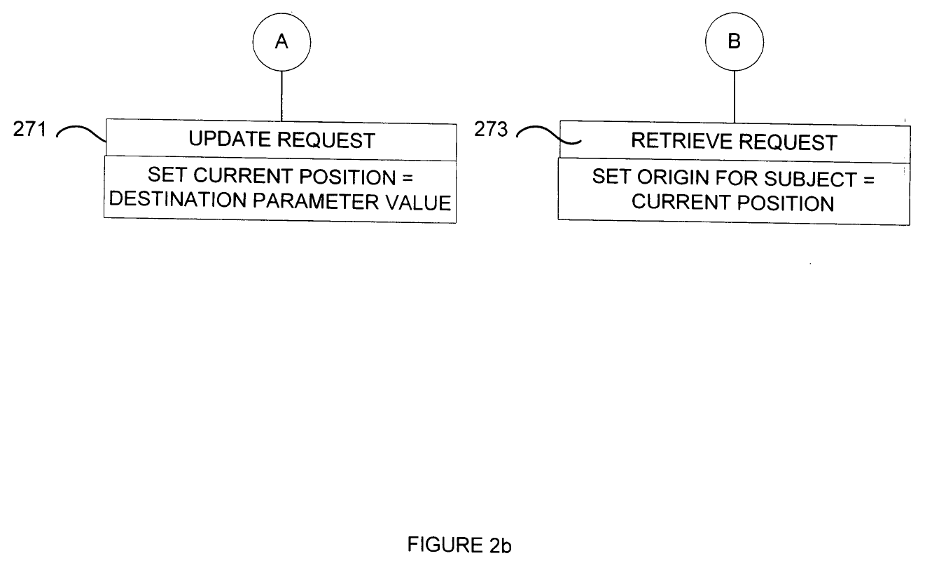

To construct the action structure, the system includes a database that contains, for each ISM structure, also referred to as a construct, a list of mandatory and optional parameters. It also contains, for each ISM structure, a list of action words that correspond to it. For each action word and for each parameter, the ISM structure contains the information about how the parameter can be introduced in a sentence when the considered action word is used. For example, a parameter could be introduced by a direct object or using an adverbial introduced by a given preposition. For example, with respect to FIG. 2a and FIG. 2b, there is illustrated such a set of parameters for the verb “to walk” when used intransitively in the sense of “to move forward by putting one foot in front of the other”. This definition corresponds to a ISM structure 200 having 5 parameters. These parameters are the origin of the movement 210, the destination of the movement 220, the surface on which the movement occurs 230, the place where the movement occurs 240 and the orientation of the movement with respect to an object or a being 250. The two last ones, 240 and 250, are optional for the animation of a movement. For each of these parameters, the chart gives a list of prepositions that can introduce it when the verb used is “to walk”.

For each ISM, the ISM database contains a list of passions. For each passion, there is defined a list of words that have an impact on the value of the passion when they are used and to each word corresponds a value. An example is shown in FIG. 2a, in which the passion that can be modified is the speed of the movement 260.

For the analysis of multiple sentences, a contextual database that contains information about the objects in the scene is used. Sometime, a sentence alone does not contain enough information to be animated, but this information is present contextually, either in a previous sentence or somewhere else in the text. For this reason, information can be stored in this contextual database when analyzing a sentence and retrieved later. In order to use this database, each ISM contains information about how to update the database information when analyzing a sentence. Also, for each parameter, the contextual database contains a list of requests that can be executed in order to find the value of the particular parameter. Examples of such requests will be described hereinbelow with respect to FIG. 2a and FIG. 2b.

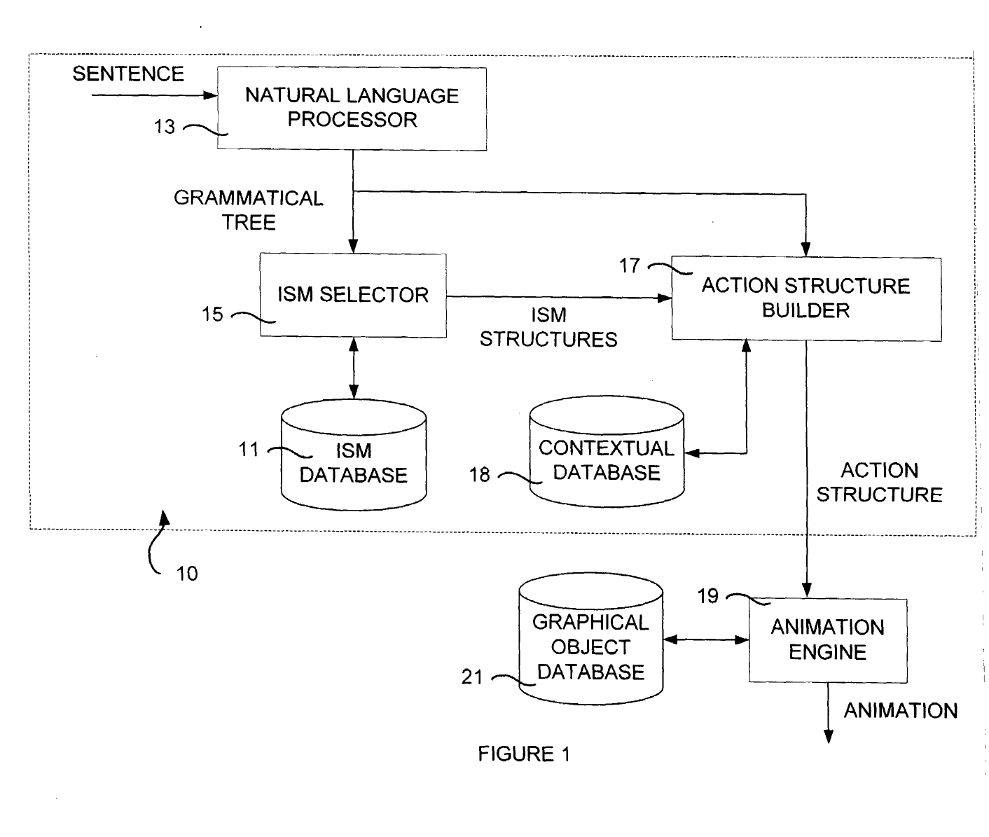

A preferred embodiment of the present invention is illustrated in FIG. 1. The system 10 preferably includes a natural language processor (NLP) module 13, which receives as an input a sentence/text in natural language that is to be processed such that it is in a form suitable for animation. The NLP module 13 outputs a grammatical tree, which is a structured organization of the sentence elements according to their grammatical clause/function. The grammatical tree is provided to an ISM or construct selector module 15, which is also in communication with an ISM structure or construct database 11. The ISM selector module 15 retrieves the action word(s) from the grammatical tree and retrieves from the ISM structure database 11, at least an ISM structure corresponding to each of the action words.

The ISM structures thus retrieved are provided to an action structure builder (ASB) module 17. The ASB module 17 analyzes each ISM structure and the grammatical tree of the sentence, in order to build an action structure. The ISM structure acts therefore as a template containing all necessary parameters and passions for representing the action described in the natural language text analyzed. The ASB module 17 scans the grammatical tree in order to provide values to the parameters and the passions. The contents of the contextual database 18 can also be used to find this information. The action structure will consist of the ISM structure for the identified action word, the ISM parameters and passions, the parameter and passion values and the relationships between them. The action structure thus built is provided to an animation engine 19, which retrieves graphical objects from a graphical object database 21 and animates them according to the action structure contents.

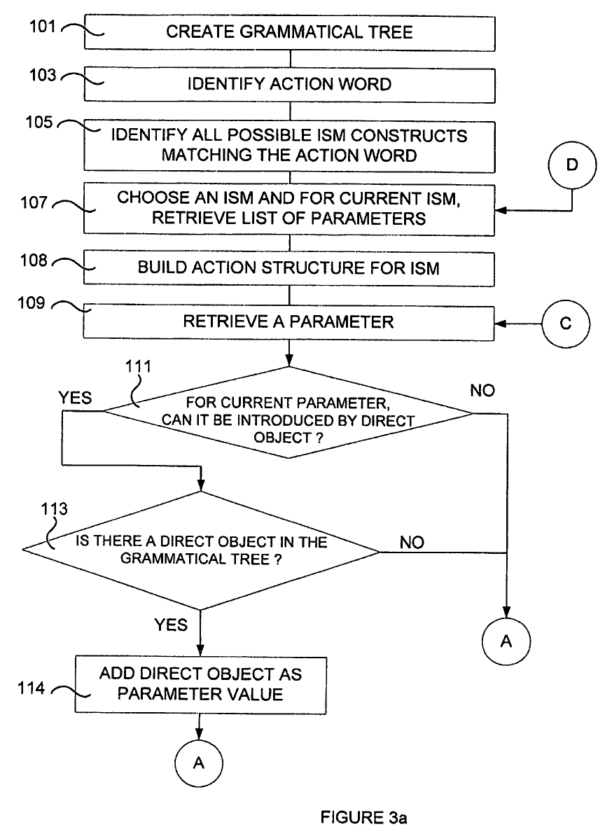

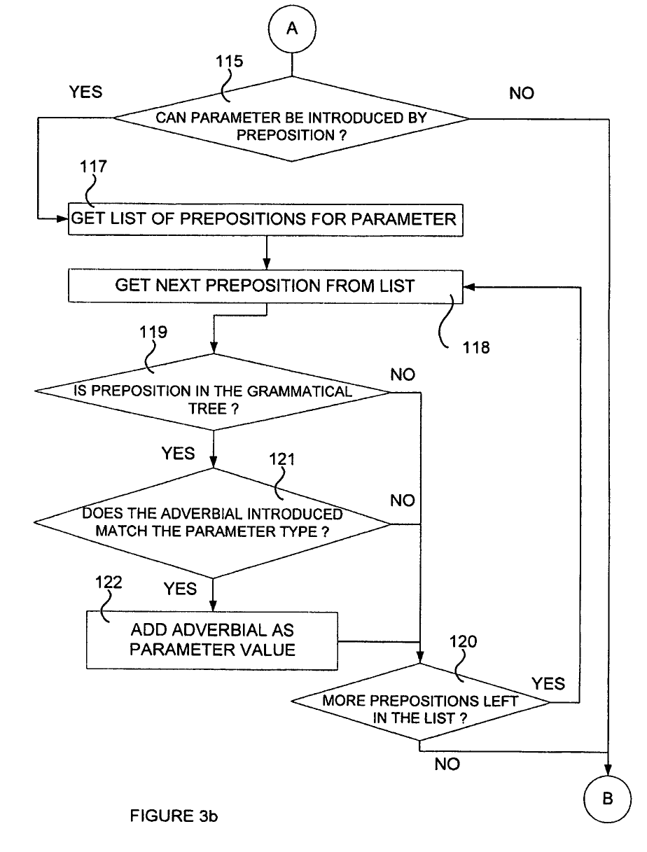

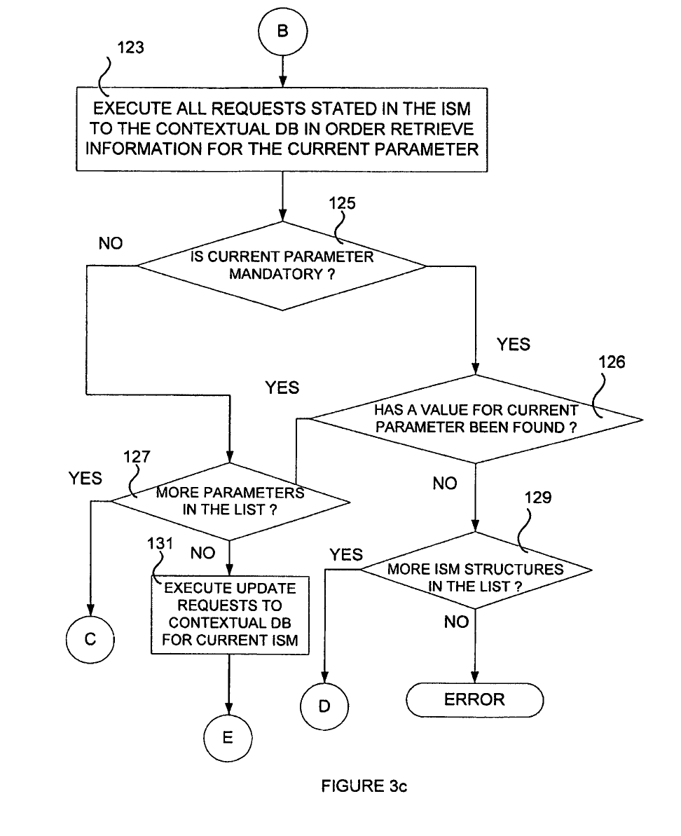

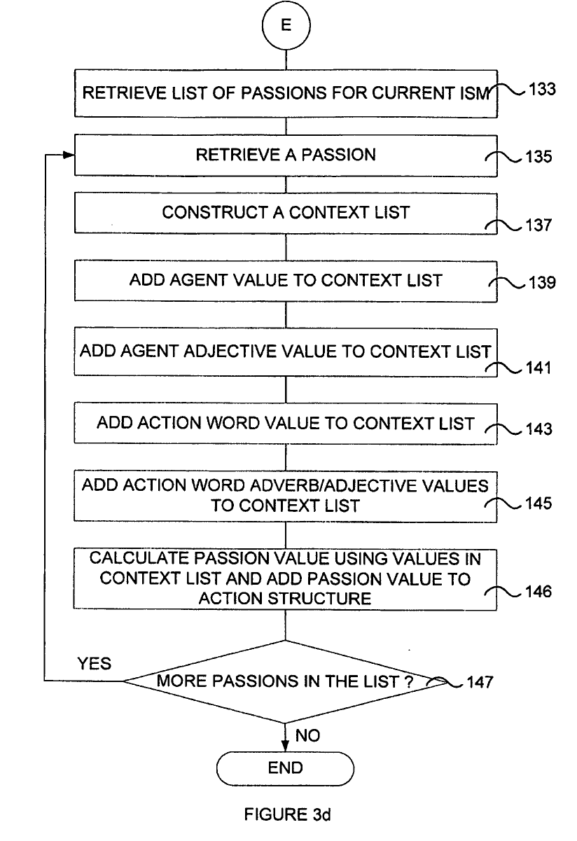

Now, with respect to FIGS. 3a, 3b, 3c and 3d, which are flow charts of the method of the present invention, the construction of an action structure for a sentence will be described. With respect to FIG. 3a, in a first step 101, natural language processing techniques, well-known to those skilled in the art, are applied in order to build the grammatical tree of the sentence. In a next step 103, the grammatical tree is parsed in order to identify the action word. In a following step 105 a list of all possible ISM structures for this action word are retrieved. In a next step 107, an ISM is chosen from the list with its corresponding parameters. Then, in a next step 108, an empty action structure is built, containing all parameters for the chosen ISM structure, but without any assigned values. Each parameter of the empty action structure is retrieved in step 109, and the grammatical tree of the sentence will be analyzed in order to determine whether a value can be assigned to it. The parameter will be analyzed as whether it can be introduced by a direct object in step 111. If so, the system will check whether a direct object exists in the grammatical tree, at step 113. If not, the system will proceed to point A, or from step 115, as illustrated by FIG. 3b, and if so, the direct object will be provided as the value of the parameter in the action structure in step 114. If it has been determined at step 111 that the parameter is not a direct object, the system will go to step 115, or point A, of FIG. 3b. Point A starts with a check to whether the parameter can be introduced by a preposition at step 115. If so, a list of prepositions for that parameter is retrieved at step 117. For each preposition in the list, the system checks whether the preposition exists in the grammatical tree at step 119. In step 121, if such a preposition exists, the type of information introduced by the preposition is compared with the parameter type to verify a match. Step 121 is necessary since a preposition can introduce more than one type of information. For example, with the verb to walk, the preposition “from” can introduce the origin of the movement. However, in the sentence “I walk from three to six o'clock”, the preposition “from” does not introduce the origin because the origin must be a place and “three o'clock” is not a place. If a match is found at step 121, then the adverbial is added as the value of the corresponding parameter in the action structure in step 122. Similarly, other prepositions from the preposition list are checked until all prepositions that can introduce a given parameter have been considered, as illustrated by the loop returning from step 120 back to step 118 in order to shift the analysis to the next preposition in the preposition list.

The next series of steps starts at point B as illustrated by FIG. 3c, with step 123, wherein the requests stated in the ISM for the current parameter are executed in order to retrieve information from the contextual database 18. This information is added to the corresponding parameter value. In a next step 125, the system checks whether the current parameter is mandatory, i.e. if it is necessary for having a sufficient description of the action to be animated. If it is not mandatory, the system checks in step 127, if there are other parameters in the list for the current ISM. If such other parameters exist, then the system continues the analysis from step 111, at point C of FIG. 3a, for each of the remaining parameters. If no other parameters exist, then all parameters for a given ISM structure have values defined and the system continues at step 131 where it executes updates to the contextual database as per the requests stated in the ISM structure and proceeds to point E illustrated by FIG. 3d.

If the parameter is mandatory at step 125, the system checks, in step 126, whether a value for the current parameter has been found. If a value has been found, the system will proceed to look at other parameters, as per step 127. If no value has been found, the system checks whether there are other ISM structures in the list of possible matches for the current action word, such as shown in step 129. If other matches exist, then the analysis is repeated from step 107, at point D of FIG. 3a. If no other matches exist, an error message is generated.

The steps that follow step 131, or from point E, are illustrated on FIG. 3d. These steps are executed in order to determine the values of the different passions. At step 133, a list of passions for the current ISM is retrieved. The system then retrieves a passion from the list at step 135 and creates an empty list (step 137). At step 139, the system looks in the grammatical tree for the word that corresponds to the agent of the action and adds the value stated in the ISM for the current passion and this word to the list. At step 141, the same action is done for every adjective that refers to the agent and, after that, for the action word (step 143). Finally, at step 145, the same action is done for every adverb that refers to the action word (when the action word is a verb) or for every adjective that refers to the action word (when the action word is a noun). At step 146, the system applies a function to the list of values. The result of the application of the function is a number which is added to the action structure as the value of the current passion. In one embodiment of the invention, this function is set in the system and is the same for all the passions and ISMs. In the described embodiment, as shown in FIG. 2a, the first values in the list have a greater importance than the last values when determining the passion value. For example, considering the speed passion, the function should return a lower value for “the turtle walks quickly” than “the cheetah walks slowly” and for “Peter strolls quickly” than “Peter trots slowly”. After that, the system continues at step 147 where it checks if there are remaining passions in the list. If yes, the system continues from step 135 for other passions. If no, the analysis is completed and the action structure built is sent to, for example, an animation engine.

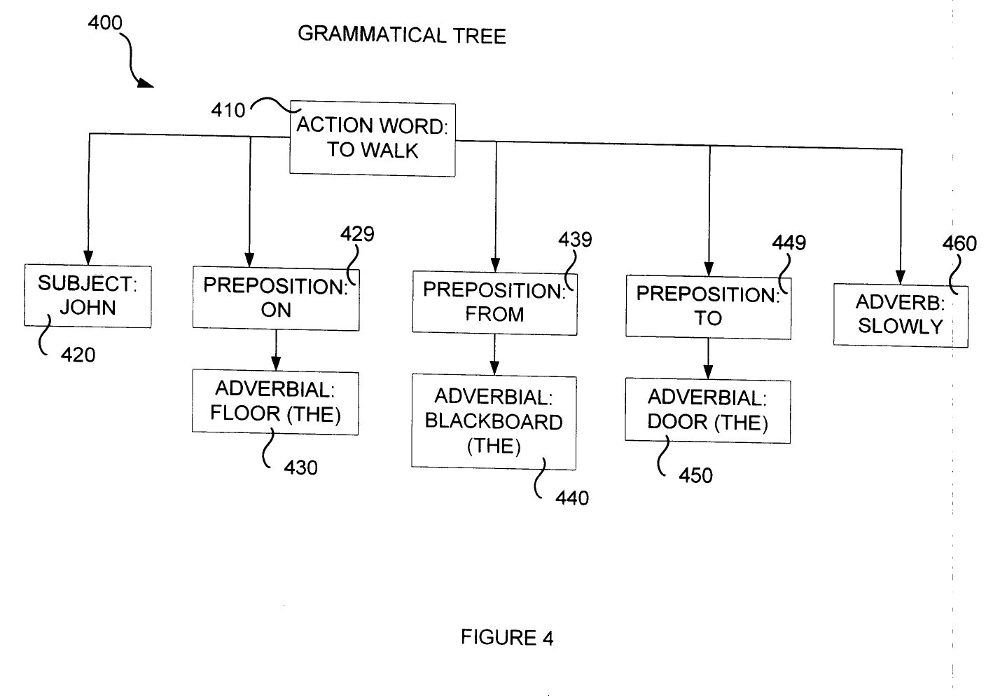

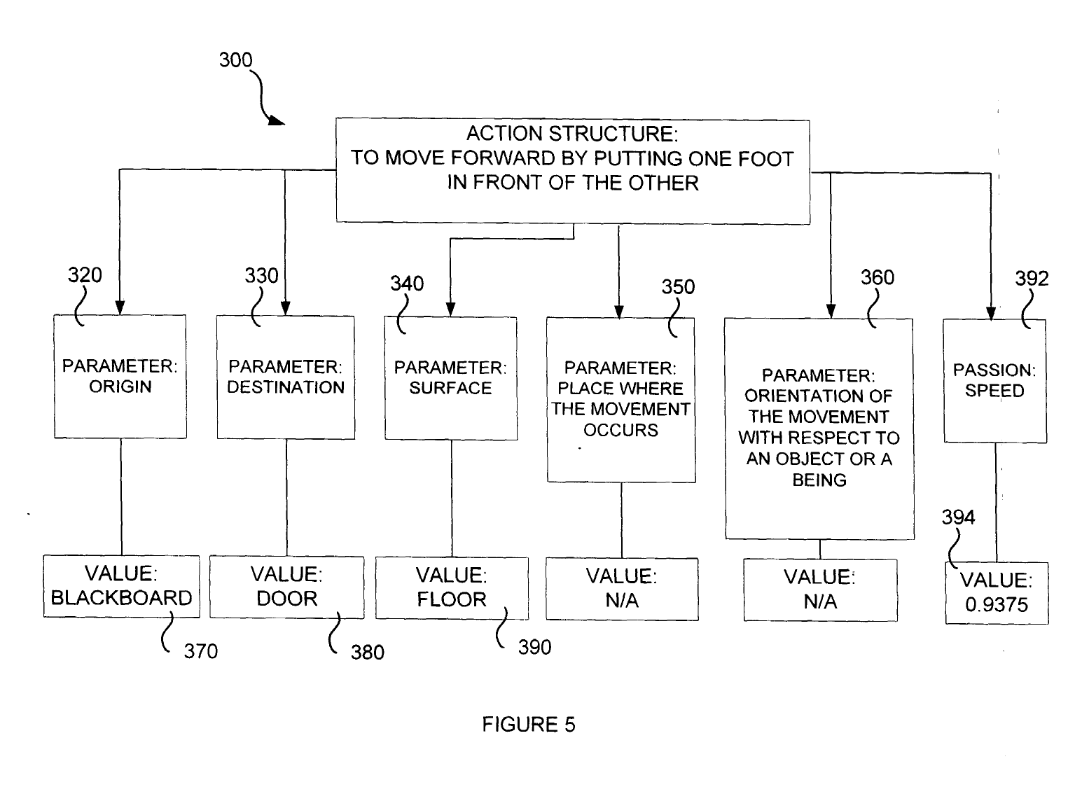

FIG. 4 is an exemplary grammatical tree of a sentence, wherein an action word has associated values, themselves categorized, for example, as direct objects, prepositions and adverbials. FIG. 5 is an action structure for the sentence of FIG. 4. The construction of the action structure according to the present invention is explained below.

The sentence that is used for this example is “John walks slowly on the floor from the blackboard to the door.” The system will analyze the sentence in order to identify the action word, create a corresponding action structure for a possible ISM and then assign values to the parameters in the action structure using the other elements of the sentence. The contextual database is not used in this example.

In a first step, according to the natural language processing methods described above, the sentence is analyzed and a grammatical tree is built. With respect to FIG. 4, the root of the grammatical tree is the verb “to walk” 410 and connected to it are the subject “John” 420 and the adverbial elements “on the floor” 430, “from the blackboard” 440 and “to the door” 450. Each of the adverbials is introduced by prepositions “on” 429, “from” 439 and “to” 449, respectively. The adverb “slowly” 460 is also connected to the root.

The first step after the natural language processing is to identify the action word, which is the root node of the grammatical tree in the example given. The action word in the present example is the verb “to walk” and it is intransitive. In a next step, the system will retrieve a list of possible ISM structures for this action word. Because the intransitive form of the verb to walk is considered, there is only one ISM for which the verb has the meaning of “to move forward by putting one foot in front of the other”. If the system was not making the distinction between transitive and intransitive meanings of “to walk”, there would have been more than one ISM for “to walk”. For example the ISM is not the same in the present example and in the sentence “John walks his dog”.

In the present example, since there is a single possible ISM, the system retrieves the parameter list associated with the ISM and necessary for building an action structure.

As shown in FIG. 2a, there are three mandatory parameters for the ISM of the intransitive verb “to walk”: an origin 210, a destination 220 and a surface 230. There also are two optional parameters: the place where the movement occurs 240 and the orientation of the movement with respect to an object or a being 250.

An action structure is constructed as shown in FIG. 5. Initially, the action structure does not contain the matching values for each of the parameters. According to the method of the current invention, a first parameter from the parameter list is considered, in this case the origin 320.

For this parameter, the first check is whether the current parameter can be introduced by a direct object. The answer is no since an intransitive verb is being used. The current parameter can be introduced by an adverbial so the system retrieves a list of prepositions that can introduce it. According to FIG. 2a, these prepositions are “from, from within, out of and outside”. First, the preposition “from” is considered. There is an adverbial introduced by the preposition from in the grammatical tree and this adverbial is the word “blackboard” 440 which can be considered a place, so the adverbial matches the parameter. The word “blackboard” 440 will then be added to the action structure as the value of the parameter “origin” 320.

This information says that the blackboard is the origin of the movement. Because the preposition “from” was not the only one in the list, all other prepositions in the list need to be processed similarly. In this case, no other values will be found since there are no adverbials that are introduced by any of the prepositions “from within, out of and outside”. After that, the system 10 considers whether information for the present parameter is available from the context, as explained above.

The system 10 then verifies whether the current parameter is mandatory, which is the case, and then whether a parameter value has been found, which is also the case as it has been established that the blackboard is the origin. In that case, the algorithm can continue, if there are remaining parameters in the parameter list.

The system 10 therefore continues to analyze the grammatical tree 400 with respect to each of the remaining parameters. For the parameter destination 330, the system identifies the preposition “to” 449 which introduces the adverbial “door” 450 in the grammatical tree 400. The value is added to the action structure as the value “door” 380 corresponding to the parameter destination 330. Similarly, the parameter “surface” 340 is assigned the value “floor” 390, which is identified from the use of the preposition “on” 429 in the grammatical tree.

The process of finding values for the parameters is completed with the analysis of the last two parameters 350, 360, for which no values are found in the grammatical tree 400. However, as these are optional parameters, the action structure is considered to be valid.

After that, the system 10 verifies the words in the grammatical tree in order to calculate the values of the passion parameters. To do that, the system retrieves the list of passions from the ISM structure. In the example, there is only one passion, which is the speed 260. This passion is considered and an empty list is created. First, the agent “John” is considered. Because John is a human, assuming the system knows this information, the value 261, which is the value for human and is equal to 1, is added to the list. There are no adjectives that refer to John. The action word in the grammatical tree is the verb “to walk” and the value 262, which is equal to 1, is added to the list. The adverb “slowly” refers to the verb. Because of that, the value 263, which is equal to 0.75, is added to the list. The list is [1, 1, 0.75] and a function is applied to it in order to calculate the value of the passion speed according to different weightings to be given to each value. In this example, the function that is used is f where f([x₁, x₂, . . . xₙ])=x₁*(((f([x₂, . . . xₙ])−1)*c)+1) if the list has more than one entry, and f([x])=x if the list has a single entry. The constant c corresponds to the weighting to be given to each value and is set between 0 and 1. If its value is near 1, the values at the end of the list have a great effect on the passion value. If its value is near 0, the values at the end of the list have a negligible effect on the passion value. For the example, the value of c is set to 0.5. Using this information, f([1, 1, 0.75])=0.9375. In the action structure, the value of the speed passion 392 is set to 0.9375.

This value is used by the animation engine 19 to set the speed of the animation. The speed of the movement in the animation is proportional to the passion value. For example, the calculated value means that the speed of this movement in the animation is equal to 93.75% of the speed of the animation of the same action structure, but with a speed value equal to 1. The information gathered and structured in the action structure allows the system 10 to animate the action described in the analyzed natural language text.

The agent, i.e. the entity performing the action, is an important parameter of a movement and is preferably included in the action structure. It is usually easy to find the value of this parameter. When the action word is a verb in an active voice, the agent can be identified as being the subject of the verb. If the action word is a verb in a passive voice, the agent performing the action may appear in a “by the . . . ” phrase or may be omitted and the subject in that case receives the action expressed by the verb.

The method of the present invention differentiates between direct objects and adverbials (i.e. modifiers of time, place, manner, etc.) because direct objects are not introduced by a preposition and can therefore be easily identified. Indirect objects are usually introduced by the preposition “to”. For that reason, the method could find information about parameters that are introduced by an indirect object as if it was an adverbial introduced by the preposition “to”. Nevertheless, it is possible that the indirect object is not introduced by a preposition. For example, in the sentence “I give Mary a kiss.”, “Mary” is the indirect object which is not introduced by any preposition.

To allow for consideration of indirect objects in general, the method of the present invention could be modified to consider indirect objects separately from adverbials, in an analogous manner to that for direct objects.

In the preferred embodiment of the present invention, the analysis of the grammatical tree 400 stops after sufficient information is gathered to define values for all mandatory parameters of a given ISM. It means that the system considers this ISM as the correct one because enough information has been found in the text and the context to construct an animation. In another embodiment however, the system could continue and try to construct an action structure for all the possible ISMs for a given action word. This way, the system could return more than one action structure 300 if it succeeds in mapping all mandatory parameters for more than one ISM. This would be advantageous, for example if the sentence to animate is ambiguous and may have more than one meaning.

The method according to the present invention preferably uses context information to better define parameter values. Such a feature is important if the text to animate contains more than one sentence because the information about a parameter could be in a sentence that is not currently being analyzed. For example, if a succession of sentences describes a succession of movements using the verb “to walk”, when analyzing a sentence, the origin may not be explicit, but could be the destination of the movement of the previous sentence. For example, consider the text: “John walks from the blackboard to the door. John walks to the elevator.” According to step 131 of the invention, shown in FIG. 3c, when analyzing the first sentence, the system has to execute the update requests stated in the ISM structure. With respect to FIG. 2b showing points A and B of FIG. 2a, in this case, there is only one request 271 which is to set in the contextual database 18, the position of the object that is the subject of the action to be the value of destination parameter. In this example, the position of object “John” is set to “the door”. When analyzing the second sentence, according to step 123 shown in FIG. 3c, for each parameter, the system has executed the requests stated in the ISM structure in order to find a value for the respective parameter. When considering the origin parameter, which is not explicit in the sentence, the system performs the retrieve requests 273 shown in FIG. 2b and searches the contextual database 18 for the position of the object that is the subject of the action. The position of the subject “John” is retrieved from the contextual database 18 and the value of the origin parameter is set to this position, which is “the door” in the example.

Usually, the action word is a conjugated verb, but this is not always the case. Such is the case in the sentence: “He is looking at the walk of the clown.” In this example, there are two action words which are the verb “to look at” and the noun “walk”. There are also two ISMs in this sentence, that is, two movements to animate which are the action of looking and the action of walking. This also means that two action structures must be constructed for this sentence. Because the “walk” is also the direct object of the action of looking, the action structure of “walk” is a parameter of the action structure of “to look at”. This example shows that an action structure can be the parameter of another one. The agent parameter is particular in the sense that it cannot be an action structure. To analyze sentences that contain more than one action word, the system can be modified in a way that every step from step 105 is executed for each of these action words.

If the action word is a verb, it is important, when analyzing a sentence to identify whether the verb is the transitive or intransitive form. Also, it is important that different ISM structures correspond to different forms of the same verb. For example, the intransitive form of the verb “to walk” belongs to the ISM “to move forward by putting one foot in front of the other”, but this is not the case for the transitive form. If this verification is not done, the system could construct an action structure for this ISM structure for the sentence “John walks his dog on the floor from the blackboard to the door.” Even though all mandatory parameters for this ISM structure have values defined in the sentence, the action cannot be correctly modelled because no parameter for a direct object (“his dog”, in this case) is built into the ISM structure.

The method as described does not consider that the analyzed sentence can have more than one clause, such as the sentence: “John walks and eats a sandwich.” The grammatical tree for this sentence has the conjunction “and” as a root and the two sub-trees corresponding to each clause: “John walks” and “John eats a sandwich” which can be analyzed by the system separately. Therefore, the analysis of this sentence would return two action structures. It would be necessary, in that case, to add to the system the means to determine if these two actions must be animated at the same time or consecutively.

According to the mapping described above, an adverbial introduced by the preposition “in” may introduce a destination, as well as a place in which the movement occurs. For example, in the sentence “Mary walks in the room.”, at first sight, there could be an ambiguity in the mapping for the verb “to walk” since it is not clear whether “the room” is the place where the movement occurs or the destination. The ambiguity could be avoided by knowing where Mary is before the movement. If Mary is already in the room, then the room is the place where the movement occurs. If not, the room must be the destination.

When trying to find a value for a parameter, the system considers all prepositions. This way, it is possible that the system 10 finds more than one possible value for a given parameter. For the parameters of the ISM structure considered in the example, this should not be possible because all the parameters are places and it is not possible to be in two places at the same time. However, in the sentence “I walk to the desk in the office.”, depending on the grammatical tree returned by the natural language processing algorithms, the system 10 could build one action structure with two elements of information for the destination (the desk and the office). Unfortunately, this grammatical tree would not be correct. For example, the sentence could mean “I walk in the office and then I walk to the desk.” This way, there are two action structures and each one has only one element of information for the destination. Another way to understand the sentence is to consider the element “in the office” as an attribute of “the desk”. This way, it is the desk that is in the room and not the action of walking. In the grammatical tree, the node for room would be under the node for desk and not directly under the node for the verb. This way, the system would find only the desk as an element of information for the destination.

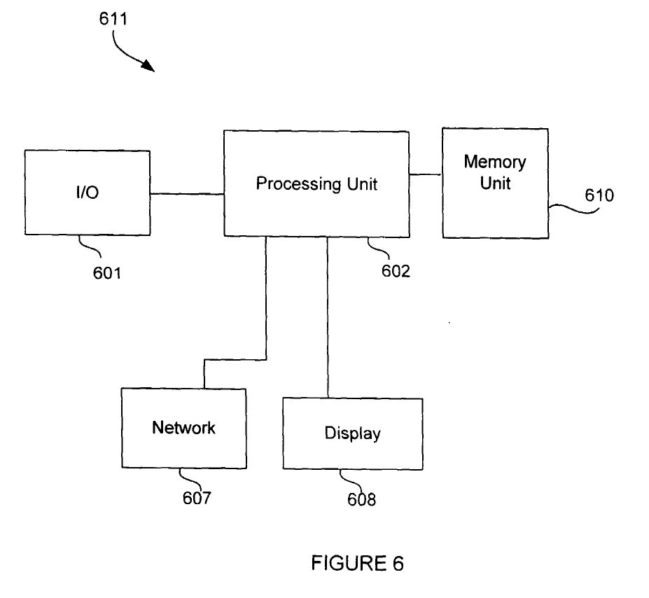

Finally, with respect to FIG. 6, a general computer system 611 having exemplary software and hardware components consistent with the present invention is illustrated. The computer system 611 can be any other programmable electronic device, coupled to other computer systems in a network or function on its own. The computer system 611, also referred to as an apparatus or as a translation system, typically has at least one processing unit 602 in connection with a memory unit 610. Processing unit 602 can represent any processing element(s): one or more processors, or microprocessors. Similarly, the memory unit 610 may be any type of memory or storage device, such as random access memory (RAM) devices, the main storage of the computer system, any supplemental levels of memory like cache memories, non-volatile or backup memories and read-only memories, and any additional external memory storage devices as well as any storage capacity used as a virtual memory. The computer system 611 also has a number of input and output devices for communicating information externally and interface with a user or operator. Examples of such devices include but are not limited to keyboards, mice, joysticks and the like, microphones and speakers and any display units 608. The system 10 can also be implemented in a computer system 611 that has an interface with one or more networks 607 permitting the communication of information with other computers coupled to the network 607. The computer system 611 can also operate under the control of an operating system (not shown), and executes or otherwise relies upon various computer software applications, components, programs, objects, modules, data structures, etc.

The routines or steps executed to implement the embodiments of the invention, however implemented, will be referred to herein as an “animation software”. The animation software comprises instructions that are resident at various times in various memory and storage devices in a computer, and when read and executed by the processing unit 602, causes the computer system 611 to perform the steps necessary to execute the various aspects of the invention.

It should be noted that the present invention can be carried out as a method, can be embodied in a system, a computer readable medium or an electrical or electromagnetic signal. Furthermore, those skilled in the art will recognize that the exemplary environment illustrated in FIG. 6 is not intended to limit the present invention. Other alternative hardware and/or software environments may be used without departing from the scope of the present invention.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A method for producing an animation from an action structure, said action structure formed by analyzing a natural language sentence expressing an action, said method comprising:
processing said sentence to create a grammatical tree comprising an action word and its associated values;
providing constructs for said action word, each of said constructs having parameter types for defining said action expressed by said action word;
identifying from said constructs at least one construct wherein at least one of said parameter types can take on at least one of said associated values thereby defining a matching value;
recording said at least one of said parameter types from said at least one construct as well as said matching value, thereby creating said action structure; and
producing an animation from said action structure.

2. The method of claim 1, wherein said identifying further comprises finding from said associated values in said grammatical tree, a direct object introducing said at least one of said parameter types, said direct object defining said matching value.

3. The method of claim 1, wherein said identifying further comprises finding from said associated values in said grammatical tree, a preposition introducing said at least one of said parameter types, said preposition introducing an adverbial and said adverbial matching said at least one of said parameter types, said adverbial defining said matching value.

4. The method of claim 2, further comprising executing a request from said at least one construct, said request for retrieving contextual information from an contextual database.

5. The method of claim 2, wherein said recording further comprises calculating a passion value using said associated values in said grammatical tree, said calculated passion value defining said matching value.

6. The method of claim 6, wherein said calculating further comprises weighing items of a context list created from said associated values, said context list having at least one of: an agent value; a adjective value for said agent value; an action word value; and an adverb value for said action word value.

7. A system for producing an animation from an action structure expressing an action, said action structure formed by analyzing a natural language sentence describing said action, said system comprising:
a database for storing constructs of an action word, each of said constructs having parameter types for defining said action expressed by said action word;
a processor module for receiving said sentence and processing said sentence to create a grammatical tree having an action word and its associated values;
a construct selector receiving said grammatical tree and accessing said database to identify from said constructs, at least one construct wherein at least one of said parameter types can take on at least one of said associated values defining a matching value;
an action structure builder for receiving said at least one construct and said grammatical tree, and for recording said at least one of said parameter types from said at least one construct as well as said matching value, thereby creating said action structure; and
an animation engine for producing an animation from said action structure.

8. The system of claim 7, further comprising a contextual database for storing grammatical trees corresponding to other sentences surrounding said sentence and thereby providing information on the context of said action, said contextual database in for communicating with said action structure builder.

9. The system of claim 7, wherein said animation engine is operatively connected to a graphical object database to retrieve graphical representations corresponding to said action structure.

10. A method for analyzing a natural language sentence describing an action, to create an action structure to be used in creating an animation of said action, said method comprising:
processing said natural language sentence to create a grammatical tree comprising an action word and its associated values;
providing constructs for said action word, each of said constructs having parameter types for defining said action expressed by said action word;
identifying from said constructs at least one construct wherein at least one of said parameter types can take on at least one of said associated values thereby defining a matching value; and
recording said at least one of said parameter types from said at least one construct as well as said matching value, thereby creating said action structure.

11. A system for analyzing a natural language sentence describing an action, to create an action structure to be used in creating an animation of said action, said system comprising:
a database for storing constructs of an action word, each of said constructs having parameter types for defining said action expressed by said action word;
a processor module for receiving said sentence and processing said sentence to create a grammatical tree having an action word and its associated values;
a construct selector receiving said grammatical tree and accessing said database to identify from said constructs, at least one construct wherein at least one of said parameter types can take on at least one of said associated values defining a matching value; and
an action structure builder for receiving said at least one construct and said grammatical tree, and for recording said at least one of said parameter types from said at least one construct as well as said matching value, thereby creating said action structure.
